(19) United States
(12) Patent Application Publication
(10) Pub. No.: US 2018/0341488 A1
(43) Pub. Date: Nov. 29, 2018

(54) MICROPROCESSOR INSTRUCTION PREDISPATCH BEFORE BLOCK COMMIT

(71) Applicant: Microsoft Technology Licensing, LLC, Redmond, WA (US)

(72) Inventor: Douglas C. Burger, Bellevue, WA (US)

(73) Assignee: Microsoft Technology Licensing, LLC, Redmond, WA (US)

(21) Appl. No.: 15/606,673

(22) Filed: May 26, 2017

(51) Int. Cl. G06F 9/30; G06F 9/38

(52) U.S. Cl. CPC G06F 9/30047; G06F 9/3842; G06F 9/382; G06F 9/30087

(57) ABSTRACT

Systems and methods are disclosed for block-based or Explicit Data Graph Execution (EDGE) processors that can predispatch instructions for a next instruction block before a current instruction block has committed. Instruction state, including instruction scheduler instruction state and other decoded control state can be stored in one or more memories. As individual instructions of a current instruction block issue, instructions for a next instruction block can be fetched, decoded, and the generated instruction state stored in the memory at the now-unused instruction slot locations. The next instruction block can be determined speculatively, or non-speculatively. Prior to committing the first instruction block, the instruction state is stored in one or more of the now-unused instruction slot locations.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance Accordingly, there is ample opportunity for improvements in processor ISAs to extend performance improvements.

### SUMMARY

Apparatus and methods are disclosed for Explicit Data Graph Execution (EDGE) and other block-based processors that can prefetch, predecode, and/or predispatch instructions before a current instruction block has committed. As part of a predispatch operation, decoded instruction data, including instruction scheduler instruction state and other control state can be stored in one or more memories. As individual instructions of a current instruction block issue, instructions for a next instruction block can be fetched, decoded, dispatched, including storing the generated instruction state in the memory at the now unused instruction slot locations. The next instruction block can be determined speculatively, or non-speculatively. Prior to committing the first instruction block, the instruction state is stored in one or more memories coupled to an instruction scheduler and/or decoded instruction store.

In some examples of the disclosed technology, an instruction decoder decodes a first instruction for a first instruction block and stores instruction state at a first portion of a memory coupled to an instruction scheduler. The first instruction can issue after its dependencies are satisfied. Prior to committing the first instruction block, instruction state for a second instruction of a second, different instruction block is decoded and stored in the first portion of the memory, thereby overwriting the first instruction state (generated for the now-issued first instruction). At a later time, the first instruction block is committed. Thus, instructions for the next instruction block can be decoded prior to committing the current instruction block. This can provide improved performance, for example, by reducing latency between determining the next instruction block, fetching next instructions, decoding next instructions, and issuing and executing the next instructions. In some examples, the next instruction block is determined, fetched, decoded, and dispatched speculatively. In some examples, a pointer is maintained to point to the first non-issued instruction of the current instruction block, and only instruction blocks before the pointer are prefetched, predecoded, and/or predispatched. The dispatched, predecoded instructions of the next instruction block can then have their issued state bit cleared to begin execution.

In some examples of the disclosed technology, a block-based processor includes an instruction decoder configured to decode instructions in a current instruction block, an instruction scheduler configured to issue individual instructions within the current instruction block, and memory storing instruction state entries for the current instruction block. The processor is configured to, prior to committing the current instruction block, overwrite instruction state entries for individual instructions of the current instruction block in the memory as the corresponding individuals instructions are issued by the instruction scheduler.

In some examples of the disclosed technology, object code for disclosed block-based processor can be emitted by receiving source, assembly, or machine code for a block-based processor, generating an order for executing a plurality of instructions in an instruction block, the generated order taking into account that the block-based processor can overwrite instruction state entries before an instruction block is committed, and emitting object code executable by the block-based processor, the object code having at least two instructions arranged according to the generated order.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Any trademarks used herein remain the property of their respective owners. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, as can be used in certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7 is block diagram outlining an example decoder and scheduler used to prefetch and predecode instructions before block commit, as can be used in some examples of the disclosed technology.

FIGS. 8A-8D illustrate examples of dispatching instructions before block commit, as can be performed in some examples of the disclosed technology.

FIG. 9 is a flowchart outlining an example method of dispatching coding instructions before block commit

FIG. 10 is a flowchart outlining an example method of generating object code for a block-based processor supporting prefetching, predecoding, and predispatching of instructions before commit

FIG. 11 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Certain of the disclosed methods can be implemented using computer-executable instructions stored on one or more computer-readable media (e.g., computer-readable media, such as one or more optical media discs, volatile memory components (including random-access memory, such as dynamic RAM (DRAM), static RAM (SRAM), or embedded DRAM (eDRAM), or non-random access memories, such as certain configurations of registers, buffers, or queues), or nonvolatile memory components (such as flash drives and hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented with software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an EDGE ISA includes information about program control flow that can be used to improve detection of improper control flow instructions, thereby increasing performance, saving memory resources, and/or and saving energy.

In some examples of the disclosed technology, instructions organized within instruction blocks are fetched, decoded, executed, and committed atomically. Intermediate results produced by the instructions within an atomic instruction block are buffered locally until the instruction block is committed. When the instruction block is committed, updates to the visible architectural state resulting from executing the instructions of the instruction block are made visible to other instruction blocks. Instructions inside blocks execute in dataflow order, which reduces or eliminates using register renaming and provides power-efficient OoO execution. An a priori compiler or a just in time (JIT) compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

As will be readily understood to one of ordinary skill in the relevant art having the benefit of the present disclosure, a spectrum of implementations of the disclosed technology are possible with various area, performance, and power tradeoffs.

### III. Example Block-Based Processor

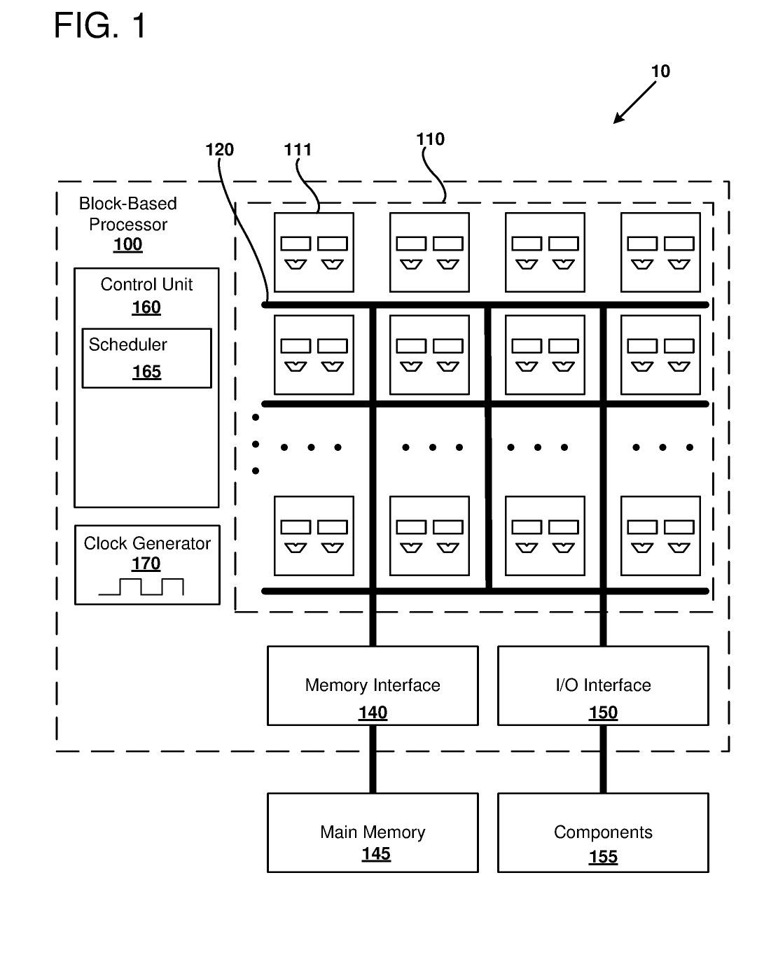

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, exception models, and other architectural features. The block-based processor includes a plurality of one or more processing cores 110, including a processor core 111. The block-based processor can be implemented in as a custom or application-specific integrated circuit (e.g., including a system-on-chip (SoC) integrated circuit), as a field programmable gate array (FPGA) or other reconfigurable logic, or as a soft processor virtual machine hosted by a physical general purpose processor.

As shown in FIG. 1, the processor cores are connected to each other via core interconnect 120. The core interconnect 120 carries data and control signals between individual ones of the cores 110, a memory interface 140, and an input/output (I/O) interface 150. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to memory 145, for example, memory located on another integrated circuit besides the processor 100 (e.g., the memory can be static RAM (SRAM) or dynamic RAM (DRAM)), or memory embedded on the same integrated circuit as the processor (e.g., embedded SRAM or DRAM (eDRAM)). The memory interface 140 and/or the main memory can include caches (e.g., n-way or associative caches) to improve memory access performance In some examples the cache is implemented using static RAM (SRAM) and the main memory 145 is implemented using dynamic RAM (DRAM). In some examples the memory interface 140 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 manages allocation of virtual memory, expanding the available main memory 145. In some examples, support for bypassing cache structures or for ensuring cache coherency when performing memory synchronization operations (e.g., handling contention issues or shared memory between plural different threads, processes, or processors) are provided by the memory interface 140 and/or respective cache structures.

The I/O interface 150 includes circuitry for receiving and sending input and output signals to other components 155, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140. In some examples the I/O signal implementation is not limited to full swing electrical digital signals, but the I/O interface 150 can be configured to provide differential signals, pulsed signals, or other suitable signals for transmitting data and control signals.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 150, modification of execution flow, and control of fetching, decoding, and dispatch. The control unit 160 can generate and control the processor according to control flow and metadata information representing exit points and control flow probabilities for instruction blocks. The control unit can be used to control data flow between general-purpose portions of the processor cores 110.

The control unit 160 can also process hardware interrupts, and control reading and writing of special system registers, for example a program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory, a hard macro processor block provided in an FPGA, or a general purpose soft processor). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 used to control instruction pipelines of the processor cores 110. In other examples, schedulers can be arranged so that they are contained with each individual processor core. As used herein, scheduler block allocation refers to directing operation of an instruction blocks, including initiating instruction block mapping, fetching, decoding, dispatching, issuing, execution, committing, aborting, idling, and refreshing an instruction block.

As used herein, “instruction fetch” is a high-level term referring to operations performed in loading instructions from memory into an instruction cache. As used herein, “instruction decode” is a high-level term referring to operations performed in transforming an encoded instruction into a decoded form for processor dispatch, issue, execution, and commit For example, various fields in an instruction (e.g., opcode, left/right/predicate target operands, broadcast operand, or input operand fields, memory address, immediate, and/or predication fields) are decoded into instruction state for use in processor dispatch, issue, execution, and commit As used herein, “instruction dispatch” is a high-level term referring to operations performed in sending instruction state to an instruction scheduler and/or to components coupled to an instruction scheduler to facilitate evaluation of an instruction's dependencies prior to issue. Any one or more of instruction fetch, instruction decode, or instruction dispatch operations for an instruction can be prefetched, predecoded, or predispatched under the appropriate conditions by performing the associated operations before the prior block commits For example, a next instruction block of a current block can have one or more instructions prefetched, predecoded, and predispatched to an instruction scheduler by storing instruction state for an instruction of the next instruction in an instruction slot where the corresponding instruction for the current instruction block has issued.

Further, instruction scheduling is a high-level term referring to operations performed by hardware scheduling of the issuance and execution of instructions within an instruction block. For example, based on instruction dependencies and data indicating a relative ordering for memory access instructions, the control unit 160 can determine which instruction(s) in an instruction block are ready to issue and initiate issuance and execution of the instructions. Processor cores 110 are assigned to instruction blocks during instruction block mapping. The recited stages of instruction operation are for illustrative purposes and in some examples of the disclosed technology, certain operations can be combined, omitted, separated into multiple operations, or additional operations added. The scheduler 165 schedules the flow of instructions, including allocation and de-allocation of cores for performing instruction processing, control of input data and output data between any of the cores, register files, the memory interface 140, and/or the I/O interface 150. The scheduler 165 can be configured to prefetch, predecode, and/or predispatch instructions of a next instruction block prior to committing the currently-executing instruction block by, for example, storing instruction state for the next instructions in instructions slots no longer being occupied by issued instructions of the current instruction block.

The block-based processor 100 also includes a clock generator 170, which distributes one or more clock signals to various components within the processor (e.g., the cores 110, interconnect 120, memory interface 140, and I/O interface 150). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

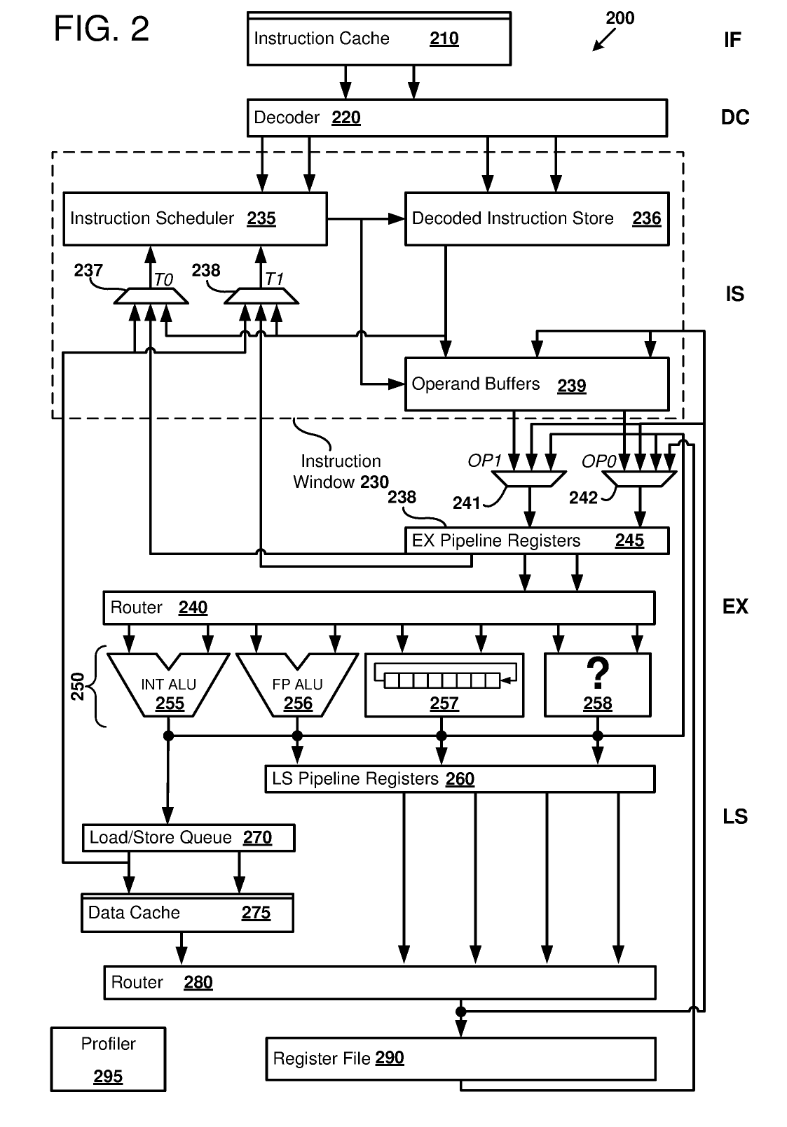

FIG. 2 is a block diagram further detailing an example microarchitecture 200 for implementing the block-based processor 100, and in particular, an instance of one of the block-based processor cores, as can be used in certain examples of the disclosed technology. For ease of explanation, the exemplary microarchitecture has five pipeline stages including: instruction fetch (IF), decode and dispatch (DC), issue, including operand fetch (IS), execute (EX), and memory/data access (LS). However, it will be readily understood by one of ordinary skill in the relevant art having the benefit of the present disclosure that modifications to the illustrated microarchitecture, such as adding/removing stages, adding/removing units that perform operations, and other implementation details can be modified to suit a particular application for a block-based processor.

As shown in FIG. 2, the processor core includes an instruction cache 210 that is coupled to an instruction decoder 220. The instruction cache 210 is configured to receive block-based processor instructions from a memory. In some FPGA implementations, the instruction cache can be implemented by a dual read port, dual write port, 18 or 36 Kb (kilobit), 32-bit wide block RAM. In some examples, the physical block RAM is configured to operate as two or more smaller block RAMs. The instruction decoder 220 generates instruction state data, including scheduler data and instruction control data. The scheduler data is dispatched to and used by an instruction scheduler to determine which instructions in an instruction block are ready to issue and to select a next ready instruction to issue, and examples of suitable scheduler data can include decoded instruction ready state, active instruction ready state, ready state for input data or predicate operands of an instruction, instruction issued state, or instruction inhibit state. The instruction control data include bits representing control signals that can be used to control processing of data in a datapath. In some examples, the instruction control data is used to control a finite state machine implementation. In other examples, the instruction control data is used to access a microcoded implementation for generating control signals.

The processor core further includes an instruction window 230, which includes an instruction scheduler 235, a decoded instruction store 236, and a plurality of operand buffers 239. In FPGA implementations, each of these instruction window components 230 can be implemented including the use of LUT RAM (e.g., with SRAM configured as lookup tables) or BRAM (block RAM). The instruction scheduler 235 can send an instruction identifier (instruction ID or IID) for an instruction to the decoded instruction store 236 and the operand buffers 239 as a control signal. As discussed further below, each instruction in an instruction block has an associated instruction identifier that uniquely identifies the instruction within the instruction block. In some examples, instruction targets for sending the result of executing an instruction are encoded in the instruction. In this way, dependencies between instructions can be tracked using the instruction identifier instead of monitoring register dependencies. In some examples, the processor core can include two or more instruction windows. In some examples, the processor core can include one instruction window with multiple block contexts. The instructions identifier can be used to index instructions slots storing data in the instruction scheduler 235 or decoded instruction store 236. For example, when an instruction located at a particular identifier for the current instruction block issues, an instruction having the same instruction identifier can then be prefetched, decoded, and dispatched, including storing instruction state at the same instruction slot, before the current instruction block commits

As will be discussed further below, the microarchitecture 200 includes a register file 290 that stores data for registers defined in the block-based processor architecture, and can have one or more read ports and one or more write ports. Because an instruction block executes on a transactional basis, changes to register values made by an instance of an instruction block are not visible to the same instance; the register writes will be committed upon completing execution of the instruction block. It should be further noted that for a particular instance of an instruction block, any instruction can only be issued and executed once. Thus, once an instruction issues or is executed, the scheduling and decoder resources associated with those resources are essentially unused and may be allocated to an instruction of the next instruction block.

The example microarchitecture 200 also includes a hardware profiler 295. The hardware profiler 295 can collect information about programs that execute on the processor. For examples, data regarding events, function calls, memory locations, and other information can be collected (e.g., using hardware instrumentation such as registers, counters, and other circuits) and analyzed to determine which portions of a program might be optimized.

The decoded instruction store 236 stores decoded signals for controlling operation of hardware components in the processor pipeline. For example, a 32-bit instruction may be decoded into 128-bits of decoded instruction control data. The decoded instruction control data is generated by the decoder 220 after an instruction is fetched. The operand buffers 239 store operands (e.g., register values received from the register file, data received from memory, immediate operands coded within an instruction, operands calculated by an earlier-issued instruction, or other operand values) until their respective decoded instructions are ready to execute. Instruction operands and predicates for the execute phase of the pipeline are read from the operand buffers 239, respectively, not (directly, at least) from the register file 290. The instruction window 230 can include a buffer for predicates directed to an instruction, including wired-OR logic for combining predicates sent to an instruction by multiple instructions.

In some examples, all of the instruction operands, except for register read operations, are read from the operand buffers 239 instead of the register file. In some examples the values are maintained until the instruction issues and the operand is communicated to the execution pipeline. In some FPGA examples, the decoded instruction store 236 and operand buffers 239 are implemented with a plurality of LUT RAMs.

The instruction scheduler 235 maintains a record of ready state of each decoded instruction's dependencies (e.g., the instruction's predicate and data operands). When all of the instruction's dependencies (if any) are satisfied, the instruction wakes up and is ready to issue. In some examples, the lowest numbered ready instruction ID is selected each pipeline clock cycle and its decoded instruction data and input operands are read. Besides the data mux and function unit control signals, the decoded instruction data can encode ready events in the illustrated example. The instruction scheduler 235 accepts these and/or events from other sources (selected for input to the scheduler on inputs T0 and T1 with multiplexers 237 and 238, respectively) and updates the ready state of other instructions in the window. Thus dataflow execution proceeds, starting with the instruction block's ready zero-input instructions, then instructions that these instructions target, and so forth. Some instructions are ready to issue immediately (e.g., move immediate (movi) instructions) as they have no dependencies. Depending on the ISA, control structures, and other factors, the decoded instruction store 236 is about 100 bits wide in some examples, and includes information on instruction dependencies, including data indicating which target instruction(s)'s active ready state will be set as a result of issuing the instruction.

As used herein, “ready state” refers to processor state that indicates, for a given instruction, whether and which of its operands (if any) are ready, and whether the instruction itself is now ready for issue. In some examples, ready state includes decoded ready state and active ready state. Decoded ready state data is initialized by decoding instruction(s). Active ready state represents the set of input operands of an instruction that have been evaluated so far during the execution of the current instance of an instruction block. A respective instruction's active ready state is set by executing instruction(s) which target, for example, the left, right, and/or predicate operands of the respective instruction.

Attributes of the instruction window 230 and instruction scheduler 235, such as area, clock period, and capabilities can have significant impact to the realized performance of an EDGE core and the throughput of an EDGE multiprocessor. In some examples, the front end (IF, DC) portions of the microarchitecture can run decoupled from the back end portions of the microarchitecture (IS, EX, LS). In some FPGA implementations, the instruction window 230 is configured to fetch and decode two instructions per clock into the instruction window.

The instruction scheduler 235 has diverse functionality and requirements. It can be highly concurrent. Each clock cycle, the instruction decoder 220 writes decoded ready state and decoded instruction data for one or more instructions into the instruction window 230. Each clock cycle, the instruction scheduler 235 selects the next instruction(s) to issue, and in response the back end sends ready events, for example, target ready events targeting a specific instruction's input slot (e.g., predicate slot, right operand (OP0), or left operand (OP1)), or broadcast ready events targeting all instructions waiting on a broadcast ID. These events cause per-instruction active ready state bits to be set that, together with the decoded ready state, can be used to signal that the corresponding instruction is ready to issue. The instruction scheduler 235 sometimes accepts events for target instructions which have not yet been decoded, and the scheduler can also inhibit reissue of issued ready instructions.

Control circuits (e.g., signals generated using the decoded instruction store 236) in the instruction window 230 are used to generate control signals to regulate core operation (including, e.g., control of datapath and multiplexer select signals) and to schedule the flow of instructions within the core. This can include generating and using memory access instruction encodings, allocation and de-allocation of cores for performing instruction processing, control of input data and output data between any of the cores 110, register files, the memory interface 140, and/or the I/O interface 150.

In some examples, the instruction scheduler 235 is implemented as a finite state machine coupled to the other instruction window logic. In some examples, the instruction scheduler is mapped to one or more banks of RAM in an FPGA, and can be implemented with block RAM, LUT RAM, or other reconfigurable RAM. As will be readily apparent to one of ordinary skill in the relevant art having the benefit of the present disclosure, other circuit structures, implemented in an integrated circuit, programmable logic, or other suitable logic can be used to implement hardware for the instruction scheduler 235. In some examples of the disclosed technology, front-end pipeline stages IF and DC can run decoupled from the back-end pipelines stages (IS, EX, LS).

In the example of FIG. 2, the operand buffers 239 send the data operands, which can be designated left operand (LOP) and right operand (ROP) for convenience, to a set of execution state pipeline registers 245 via one or more switches (e.g., multiplexers 241 and 242). These operands can also be referred to as OP1 and OP0, respectively. A first router 240 is used to send data from the operand buffers 239 to one or more of the functional units 250, which can include but are not limited to, integer ALUs (arithmetic logic units) (e.g., integer ALUs 255), floating point units (e.g., floating point ALU 256), shift/rotate logic (e.g., barrel shifter 257), or other suitable execution units, which can including graphics functions, physics functions, and other mathematical operations. In some examples, a programmable execution unit 258 can be reconfigured to implement a number of different arbitrary functions (e.g., a priori or at runtime).

Data from the functional units 250 can then be routed through a second router (not shown) to a set of load/store pipeline registers 260, to a load/store queue 270 (e.g., for performing memory load and memory store operations), or fed back to the execution pipeline registers, thereby bypassing the operand buffers 239. The load/store queue 270 is coupled to a data cache 275 that caches data for memory operations. The outputs of the data cache 275, and the load/store pipelines registers 260 can be sent to a third router 280, which in turn sends data to the register file 290, the operand buffers 239, and/or the execution pipeline registers 245, according to the instruction being executed in the pipeline stage.

When execution of an instruction block is complete, the instruction block is designated as “committed” and signals from the control outputs can in turn can be used by other cores within the block-based processor 100 and/or by the control unit 160 to initiate scheduling, fetching, and execution of other instruction blocks.

As will be readily understood to one of ordinary skill in the relevant art having the benefit of the present disclosure, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art having the benefit of the present disclosure that trade-offs can be made in processor performance by the design and allocation of resources within the instruction window and control unit of the processor cores 110. The area, clock period, capabilities, and limitations substantially determine the realized performance of the individual cores 110 and the throughput of the block-based processor 100.

Updates to the visible architectural state of the processor (such as to the register file 290 and the memory) affected by the executed instructions can be buffered locally within the core until the instructions are committed. The control circuitry can determine when instructions are ready to be committed, sequence the commit logic, and issue a commit signal. For example, a commit phase for an instruction block can begin when all register writes are buffered, all writes to memory (including unconditional and conditional stores) are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control circuit also controls, at least in part, allocation of functional units to the instructions window.

In some examples, block-based instructions can be non-predicated, or predicated true or false. A predicated instruction does not become ready until it is targeted by another instruction's predicate result, and that result matches the predicate condition. If the instruction's predicate does not match, then the instruction never issues.

In block-based processors that do not allow for instruction prefetching or decoding before commit, upon branching to a new instruction block, all instruction window ready state (stored in the instruction scheduler 235) is flash cleared (block reset). When a block branches back to itself (block refresh), only active ready state is cleared; the decoded ready state is preserved so that it is not necessary to re-fetch and decode the blocks instructions. Thus, refresh can be used to save time and energy in loops, instead of performing a block reset.

In examples of the disclosed technology that allow for instruction prefetching and decoding, the instruction window ready stated is cleared or overwritten on an instruction-by-instruction basis. Thus, as instructions of the next instruction block are fetched and decoded before the current instruction block commits, storage used to hold instruction scheduler and decoded instruction control state can be written into issued instruction slots on an instruction-by-instruction basis. In some examples, the block-based processor can be configured to alternate between the prefetching/predecoding/predispatching mode and another mode where the entire block is reset after a block commits For example, a system register, memory-mapped hardware location, special instruction, or instruction header can store an indication of whether the processor or particular instruction blocks can operate using prefetching and predecoding.

Since some software critical paths include a single chain of dependent instructions (for example, instruction A targets instruction B, which in turn targets instruction C), it is often desirable that the dataflow scheduler not add pipeline bubbles for successive back-to-back instruction wakeup. In such cases, the IS-stage ready-issue-target-ready pipeline recurrence should complete in one cycle, assuming that this does not severely affect clock frequency.

Instructions such as ADD have a latency of one cycle. With EX-stage result forwarding, the scheduler can wake their targets' instructions in the IS-stage, even before the instruction completes. Other instruction results may await ALU comparisons, take multiple cycles, or have unknown latency. These instructions wait until later to wake their targets.

Finally, the scheduler design can be scalable across a spectrum of EDGE ISAs. In some examples, each pipeline cycle can accept from one to four decoded instructions and from two to four target ready events, and issue one to two instructions per cycle.

A number of different technologies can be used to implement the exception event handler 231 and the instruction scheduler 235. For example, the scheduler 235 can be implemented as a parallel scheduler, where instructions' ready state is explicitly represented in D-type flip-flops (FFs), and in which the ready status of every instruction is reevaluated each cycle.

The register file 290 may include two or more write ports for storing data in the register file, as well as having a plurality of read ports for reading data from individual registers within the register file. In some examples, a single instruction window (e.g., instruction window 230) can access only one port of the register file at a time, while in other examples, the instruction window 230 can access one read port and one write port, or can access two or more read ports and/or write ports simultaneously. In some examples, the microarchitecture is configured such that not all the read ports of the register file 290 can use the bypass mechanism. For the example microarchitecture 200 shown in FIG. 2, the register file can send register data on the bypass path to one of the multiplexers 242 for the operand OP0, but not operand OP1. Thus, for multiple register reads in one cycle, only one operand can use the bypass, while the other register read results are sent to the operand buffers 239, which inserts an extra clock cycle in the instruction pipeline.

In some examples, the register file 290 can include 64 registers, each of the registers holding a word of 32 bits of data. (For convenient explanation, this application will refer to 32-bits of data as a word, unless otherwise specified. Suitable processors according to the disclosed technology could operate with 8-, 16-, 64-, 128-, 256-bit, or another number of bits words). In some examples, some of the registers within the register file 290 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, execution flags, a processor topology, or other suitable dedicated purpose. In some examples, the register file 290 is implemented as an array of flip-flops, while in other examples, the register file can be implemented using latches, SRAM, FPGA LUT RAM, FPGA block RAM, or other forms of memory storage. The ISA specification for a given processor specifies how registers within the register file 290 are defined and used.

### V. Example Stream of Instruction Blocks

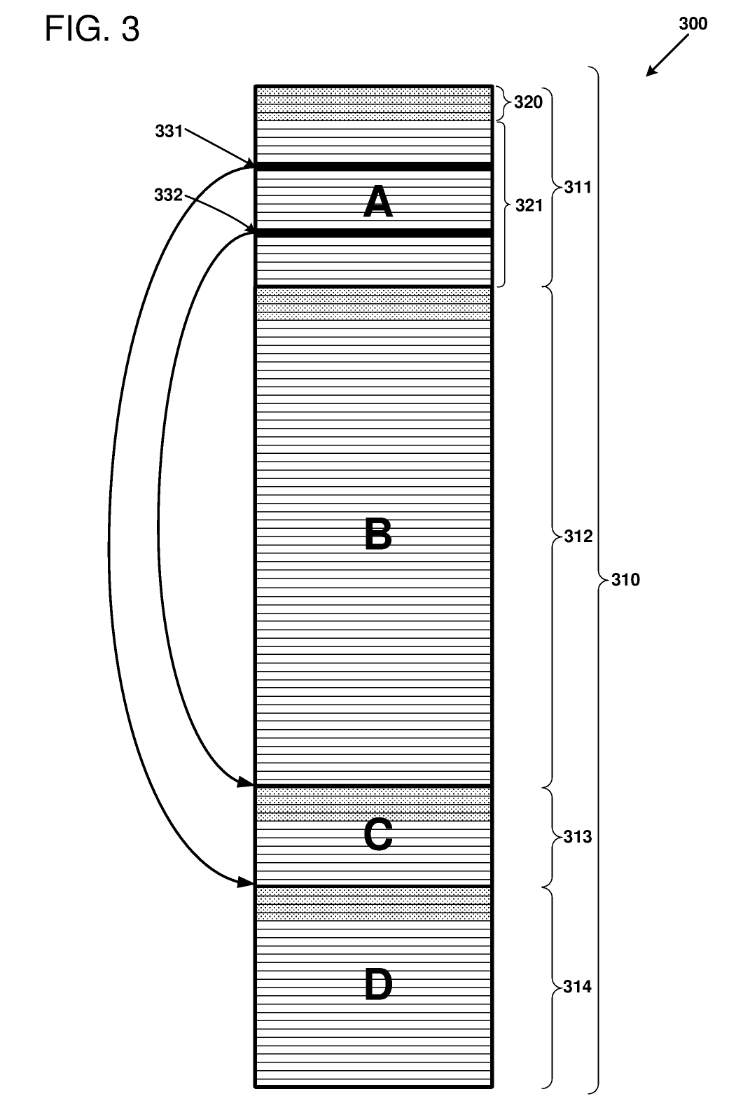

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. The stream of instructions can be stored in memory, received from another process in memory, received over a network connection, or stored or received in any other suitable manner In the example shown in FIG. 3, each instruction block begins with an instruction header, which is followed by a varying number of instructions. For example, the instruction block 311 includes a header 320 and twenty instructions 321. The particular instruction block header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of zero (0) indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution. Further, the execution flags can include a block synchronization flag that inhibits speculative execution of the instruction block.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, exception processing, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The illustrated instruction block header 320 also includes a store mask that indicates which of the load-store queue identifiers encoded in the block instructions are assigned to store operations. The instruction block header can also include a write mask, which identifies which global register(s) the associated instruction block will write. In some examples, the store mask is stored in a store vector register by, for example, an instruction decoder (e.g., decoder 220). In other examples, the instruction block header 320 does not include the store mask, but the store mask is generated dynamically by the instruction decoder by analyzing instruction dependencies when the instruction block is decoded. For example, the decoder can generate load store identifiers for instruction block instructions to determine a store mask and store the store mask data in a store vector register. Similarly, in other examples, the write mask is not encoded in the instruction block header, but is generated dynamically (e.g., by analyzing registers referenced by instructions in the instruction block) by an instruction decoder) and stored in a write mask register. The write mask can be used to determine when execution of an instruction block has completed and thus to initiate commitment of the instruction block. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In the example instruction block 311, the instructions 321 include a first branch instruction 331, which indicates a branch to instruction block C 313, and a second branch instruction 332, which indicates a branch to instruction block D 314. The branch instructions 331 332 may be predicated, and as soon as predicates for the instruction block 311 are resolved, prefetching and predecoding of the next instruction block may begin based on the target location indicated by the taken branch instruction. It should also be noted that instruction block A 311 can include one or more implicit branch targets. For example, the next instruction block in contiguous memory space is instruction block B 312. According to convention or information encoded in the instruction block header 320, instruction block B 312 may be implicitly branched to if, for example, none of the predicate dependencies for instruction block A 311 are satisfied. It should be noted that the instruction blocks depicted in FIG. 3 represent the arrangement of the blocks in memory.

### VI. Example Block Instruction Target Encoding

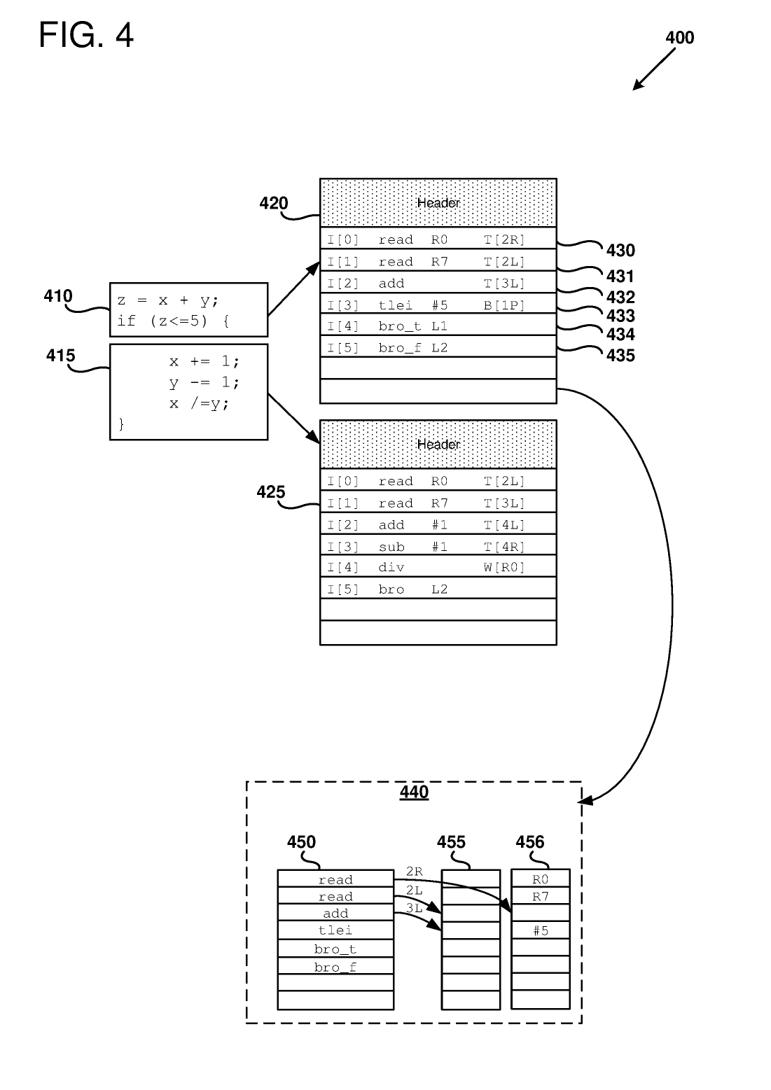

FIG. 4 is a diagram 400 depicting an example of two portions 410 and 415 of C language source code and their respective instruction blocks 420 and 425, illustrating how block-based instructions can explicitly encode their targets. In this example, the first two READ instructions 430 and 431 target the right (T[2R]) and left (T[2L]) operands, respectively, of the ADD instruction 432 (2R indicates targeting the right operand of instruction number 2; 2L indicates the left operand of instruction number 2). In the illustrated ISA, the read instruction is the only instruction that reads from the global register file (e.g., register file 290); however any instruction can target the global register file. When the ADD instruction 432 receives the results of both register reads it will become ready and execute. It is noted that the present disclosure sometimes refers to the right operand as OP0 and the left operand as OP1.

When the TLEI (test-less-than-equal-immediate) instruction 433 receives its single input operand from the ADD, it will become ready to issue and execute. The test then produces a predicate operand that is broadcast on channel one (B[1P]) to all instructions listening on the broadcast channel for the predicate, which in this example are the two predicated branch instructions (BRO_T 434 and BRO_F 435). The branch instruction that receives a matching predicate will issue, but the other instruction, encoded with the complementary predicated, will not issue. In other examples, predicates generated by instructions are target operands for one or more branch instructions in an instruction block.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R0 and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

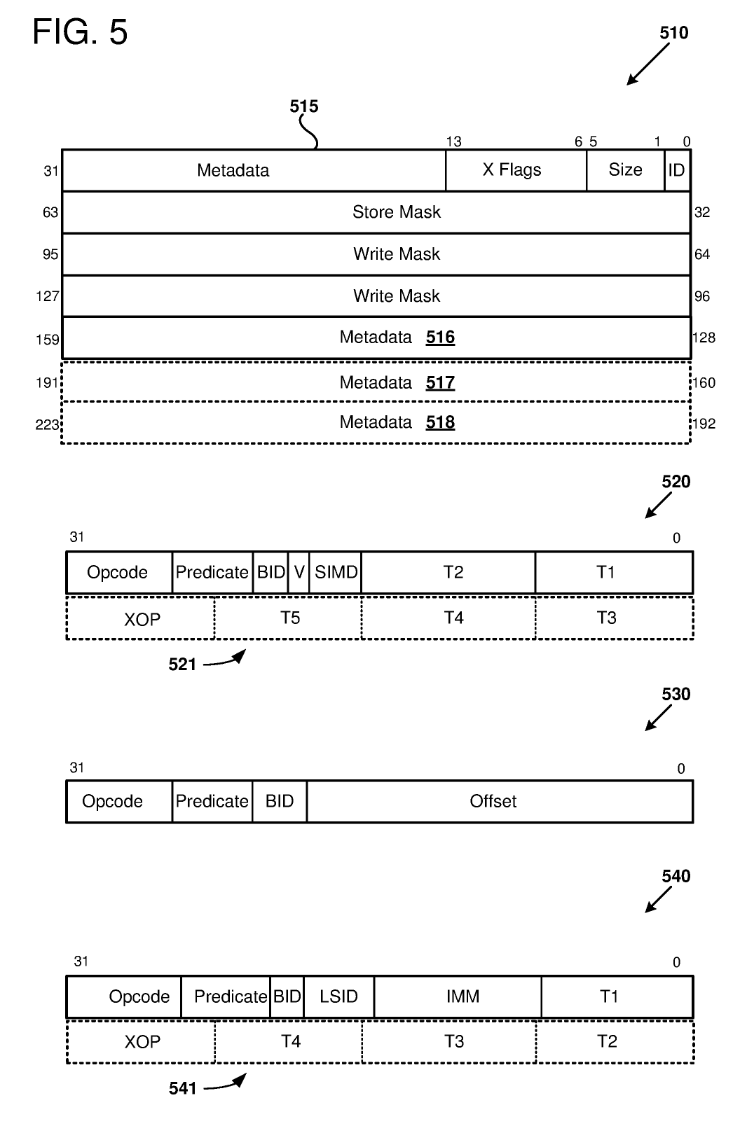

FIG. 5 is a diagram illustrating generalized examples of instruction formats for an instruction header 510, a generic instruction 520, a branch instruction 530, and a memory access instruction 540 (e.g., a memory load or memory store instruction). The instruction formats can be used for instruction blocks executed according to a number of execution flags specified in an instruction header that specify a mode of operation. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a number of execution flag fields, an instruction block size field, and an instruction header ID bit (the least significant bit of the instruction header). In some examples, the instruction header 510 includes additional metadata 515 and/or 516-518, which can be used to control additional aspects of instruction block execution and performance. In some examples, the additional metadata is used to indicate that one or more instructions are fused. In some examples, the additional meta data is generated and/or used by a hardware or software profiler tool. In other examples, the instructions may be encoded based on another word size, for example, 16-bit, 48-bit, or 64-bit words.

The execution flag fields depicted in FIG. 5 occupy bits 6 through 13 of the instruction block header 510 and indicate one or more modes of operation for executing the instruction block. For example, the modes of operation can include speculative or in-order or deterministic instruction block execution or whether to allow for prefetching, predecoding, and/or predispatch of next instructions blocks before a current instruction block has committed. The block synchronization flag occupies bit 9 of the instruction block and inhibits speculative execution of the instruction block when set to logic 1.

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign high-fanout results to broadcasts. Broadcasts support sending an operand over a lightweight network to any number of consumer instructions in a core. In other examples, the instruction can have a variable number of target fields 521 as shown (target fields T3, T4, and T5). The instruction has an XOP field, which specifies the number of extended target operands, followed by an encoding of the target fields. In other examples, a different opcode or other encoding is used to specifying instructions with variable number of targets.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specify the instructions to which the results of the block-based instruction are sent. For example, an ADD instruction at instruction slot 5 can specify that its computed result will be sent to instructions at slots 3 and 10, including specification of the operand slot (e.g., left operation, right operand, or predicate operand). Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

As will be readily understood to one of ordinary skill in the art having the benefit of the present disclosure, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The memory access instruction 540 format includes an opcode field, a predicate field, a broadcast ID field (BID), an immediate field (IMM), and a target field (T1). The opcode, broadcast, predicate fields are similar in format and function as described regarding the generic instruction. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. The immediate field can be used as an offset for the operand sent to the load or store instruction. The operand plus (shifted) immediate offset is used as a memory address for the load/store instruction (e.g., an address to read data from, or store data to, in memory). In some examples, the memory access instruction can have a variable number of target fields 541 as shown (target fields T3, T4, and T5).

### VIII. Example Processor Core State Diagram

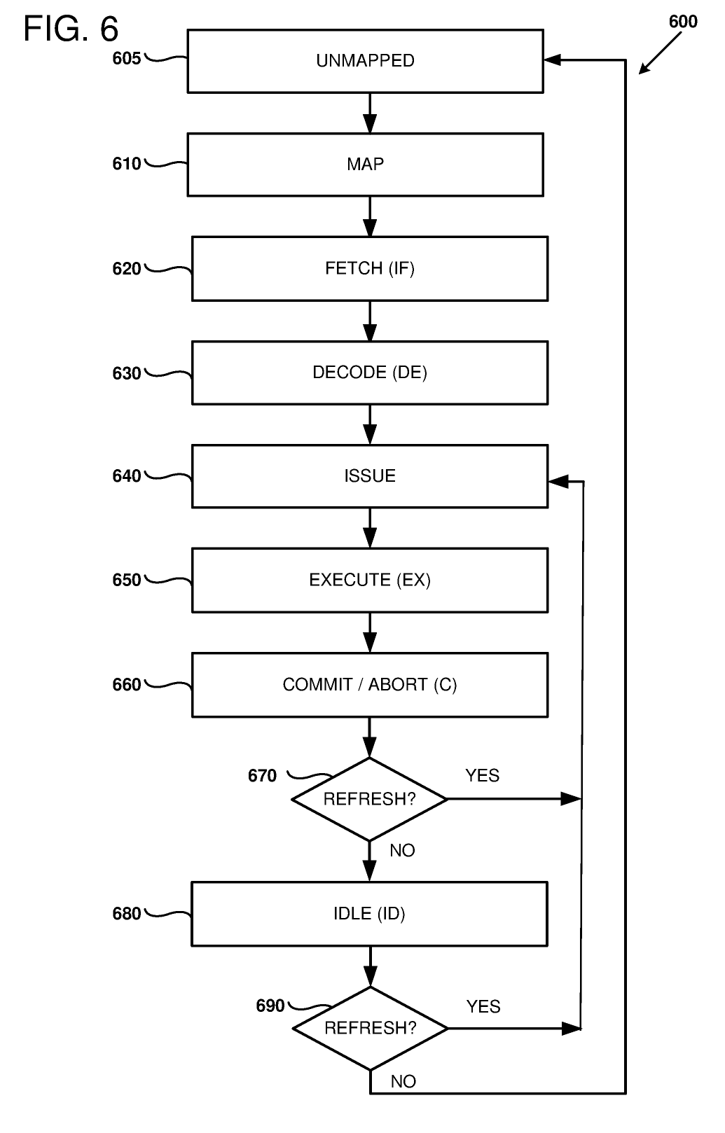

FIG. 6 is a state diagram 600 illustrating number of states assigned to an instruction block as it is mapped, executed, and retired. For example, one or more of the states can be assigned during execution of an instruction according to one or more execution flags. It should be readily understood that the states shown in FIG. 6 are for one example of the disclosed technology, but that in other examples an instruction block may have additional or fewer states, as well as having different states than those depicted in the state diagram 600. At state 605, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 610, control logic for the block-based processor, such as an instruction scheduler, can be used to monitor processing core resources of the block-based processor and map the instruction block to one or more of the processing cores.

The control unit can map one or more of the instruction block to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 620.

When the instruction block is in the fetch state 620 (e.g., instruction fetch), the mapped processor core fetches computer-readable block instructions from the block-based processors' memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 630.

During the instruction decode state 630, various bits of the fetched instruction are decoded into signals that can be used by the processor core to control execution of the particular instruction, including generation of identifiers indicating relative ordering of memory access instructions. For example, the decoded instructions can be stored in one of the memory stores discussed above regarding FIG. 2, including memory coupled to the instruction scheduler 235 and memory in the decoded instruction store 236. The decoding includes generating dependencies for the decoded instruction, operand information for the decoded instruction, and targets for the decoded instruction. The decoded instruction state is stored in a memory coupled to an instruction scheduler during a dispatch operation. In some examples, the dispatch operations includes generating decoded instruction control data used to generate control signals for an instruction pipelining and generating scheduler data used by a hardware instruction schedule to determine which instructions are ready to issue. Once at least one instruction of the instruction block has been decoded and dispatched, the instruction block can proceed to issue state 640.

During the issue state 640, instruction dependencies for dispatched instructions are evaluated to determine if an instruction is ready for issue and subsequent execution. For example, an instruction scheduler can monitor an instruction's source operands and predicate operand (for predicated instructions) must be available before an instruction is ready to issue. For some encodings, certain instructions also must issue according to a specified ordering. For example, memory load store operations are ordered according to an LSID value encoded in each instruction. In some examples, more than one instruction is ready to issue simultaneously, and the instruction scheduler selects one of the ready to issue instructions to issue. Instructions can be identified using their IID to facilitate evaluation of instruction dependencies. Once at least one instruction of the instruction block has issued, source operands for the issued instruction(s) can be fetched (or sustained on a bypass path), and the instruction block can proceed to execution state 650.

During the execution state 650, operations associated with the instruction are performed using, for example, functional units 260 as discussed above regarding FIG. 2. As discussed above, the functions performed can include arithmetical functions, logical functions, branch instructions, memory operations, and register operations. Control logic associated with the processor core monitors execution of the instruction block, and once it is determined that the instruction block can either be committed, or the instruction block is to be aborted, the instruction block state is set to commit/abort state 660. In some examples, the control logic uses a write mask and/or a store mask for an instruction block to determine whether execution has proceeded sufficiently to commit the instruction block.

At the commit/abort state 660, the processor core control unit determines that operations performed by the instruction block can be completed. For example memory load store operations, register read/writes, branch instructions, and other instructions will definitely be performed according to the control flow of the instruction block. For conditional memory instructions, data will be written to memory, and a status indicator value that indicates success generated during the commit/abort state 660.

Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 670 to determine whether the instruction block should be refreshed. If the instruction block is refreshed, the processor core re-executes the instruction block, typically using new data values, particularly the registers and memory updated by the just-committed execution of the block, and proceeds directly to the execution state 650. Thus, the time and energy spent in mapping, fetching, and decoding the instruction block can be avoided. Alternatively, if the instruction block is not to be refreshed, then the instruction block enters an idle state 680.

In the idle state 680, the processor core executing the instruction block can be idled by, for example, powering down hardware within the processor core, while maintaining at least a portion of the decoded instructions for the instruction block. At some point, the control unit determines 690 whether the idle instruction block on the processor core is to be refreshed or not. If the idle instruction block is to be refreshed, the instruction block can resume execution of instructions at issue state 640. Alternatively, if the instruction block is not to be refreshed, then the instruction block is unmapped and the processor core can be flushed and subsequently instruction blocks can be mapped to the flushed processor core.

While the state diagram 600 illustrates the states of an instruction block as executing on a single processor core for ease of explanation, it should be readily understood to one of ordinary skill in the relevant art having the benefit of the present disclosure that in certain examples, multiple processor cores can be used to execute multiple instances of a given instruction block, concurrently.

### IX. Example Block-Based Processor Core Exception Handling Microarchitecture

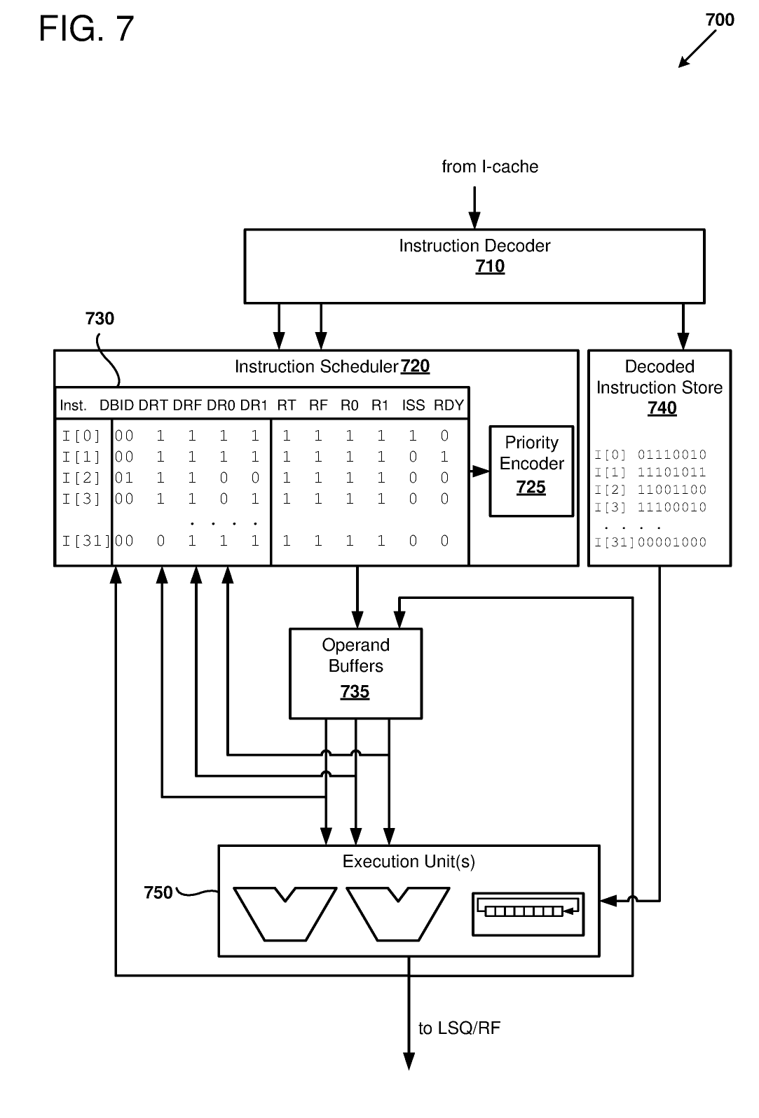

FIG. 7 is a block diagram 700 illustrating an example block-based processor core including features for instruction prefetching, predecoding, and/or predispatching instructions for a next block prior to committing the current instruction block, as can be used in certain examples of the disclosed technology. For example, the microarchitecture depicted in FIG. 2 can be further enhanced with the structures depicted in FIG. 7 in order to provide improved prefetching, predecoding, and/or predispatching in example block-based processors.

An instruction decoder 710 decodes instructions received from an instruction cache and provides instruction scheduler data 730 to an instruction scheduler 720 in order to determine instructions that are ready to issue and select one or more of the ready instructions to be executed. The instruction scheduler 720 tracks a number of different types of data for instructions in an instruction block, including decoded ready state data (e.g., DBID, DRT, DRF, DR0, DR1) and active ready state (e.g., RT, RF R0, R1, ISS, and RDY). The instruction scheduler data for each instruction in the instruction block is indexed by the instructions identifier (INSTID). When all dependencies for an instruction are satisfied, the instruction scheduler 720 sets the ready bit (RDY) to indicate that the instruction can issue and execute. As discussed above, each instruction can have a variable number of dependencies, for example left operand, right operand, and/or predicate operands. In the illustrated examples, the instruction scheduler stores data for each instruction in a table in parallel. Ready bits and other scheduling information are provided to a priority encoder 725 which selects one or more instructions to issue.

In the implementation of FIG. 7, each instruction has a logic and storage “slice” allocated to store instruction state for a particular instruction. The instruction can be identified with the INSTID. The decoded ready state is generated by the instruction decoder and is not changed by the instruction scheduler. The decoded ready state is compared to the active ready state to determine when an instruction is ready to issue. In the example instruction scheduler 720 of FIG. 7, there are six bits of decoded ready state initialized by the instruction decoder:
DBID: which indicates a 2-bit binary broadcast ID channel that the instruction receives broadcast data on, or which can be encoded 00 if the instruction receives no broadcast operands;
DRT and DRF: which indicate whether the instruction is dependent on receiving a predicate true (or a predicate false) values. In the illustrated configuration, values of DRT=1/DRF=1 indicates the instruction awaits no predicate, DRT=0/DRF=1 indicates the instruction is predicated true (awaits being targeted by a true predicate), DRT=1/DRF=0 indicates the instruction is predicated false (awaits being targeted by a false predicate), and DRT=0/DRF=0 indicates the corresponding instruction has not been decoded (the entry is empty. The same encoding can be used for active ready state RT/RF; and
DR0, DR1: which indicate that the instruction's right operand (OP0) or left operand (OP1) are ready, respectively.

For each scheduler slice, there are also a number of bits of active ready state in the instruction state 730. In the example shown, there six bits of active ready state:
RT, RF: which indicates that the corresponding instructions predicate true (or predicate false) value is ready;
R0, R1: which indicate that the corresponding right operand (OP0) or left operand (OP1) are ready, respectively;
ISS: which indicates that the instruction has issued to the instruction pipeline; and
RDY: which indicates that the corresponding instruction is ready to issue.

Any of RT, RF, R0, R1 may be set when its corresponding DRX is set by the decoder (e.g., when the instruction does not depend on the associated input operand) or an executing instruction targets that input, explicitly, or via a broadcast event. Thus, when another instruction generates a target operand for an instruction, its associated ready bit can be set.

When the RDY state indicates that the instruction is ready to issue, a ready signal can be generated and sent to an arbitration circuit, for example, a priority encoder, to select a next one or more instructions to issue. When the instruction issues, or when it is determined that the instruction will never issue (e.g., if an instruction is predicated on a true condition, and the predicate evaluates to false), then the instruction issue bit ISS is set.

The instruction decoder 710 also decodes instructions received from an instruction cache and provides decoded instruction control data that is stored in a decoded instruction store 740. In some examples, the instruction control data is used to control a finite state machine implementation. In other examples, the instruction control data is used to access a microcoded implementation for generating control signals. The instruction control data can accessed using the INSTID associated with its instruction. The instruction scheduler state and the instruction control data can be stored in any suitable storage component, which can include flip-flops, latches, and memory cells. In some examples, a shared set of memory stored the instruction scheduler state and the instruction control data, while in other examples, separate memory components are used.

As will be readily understood to one of ordinary skill in the art having the benefit of the present disclosure, different forms of representing instruction state can be used, and such processors adapted, to prefetch and predecode such variations of instruction state data. The decoded ready state and active ready state can be stored in any suitable storage component, which can include flip-flops, latches, and memory cells. In the example coding described herein, the ready state events (the decoded ready state events and the active ready state events discussed below) are encoded as a zero bit if the instruction is dependent on receiving a signal, or as a one bit if the corresponding ready state is not a dependency of the instruction, or has been received. Together these bits encode whether the instruction has been decoded, awaits one or more operand(s) (including data or predicate operands, and perhaps via a broadcast channel), or is immediately ready to issue.

The operations for implementing the instruction can be performed by execution units 750. Operands that are generated for consumption by instructions are temporarily stored in a number of operand buffers 735. The operand buffers are monitored by the instruction scheduler 720, and when all of an instruction's dependencies are satisfied, is available for issue by the scheduler.

### X. Example Transfer of Control and Resuming During Exception Handling

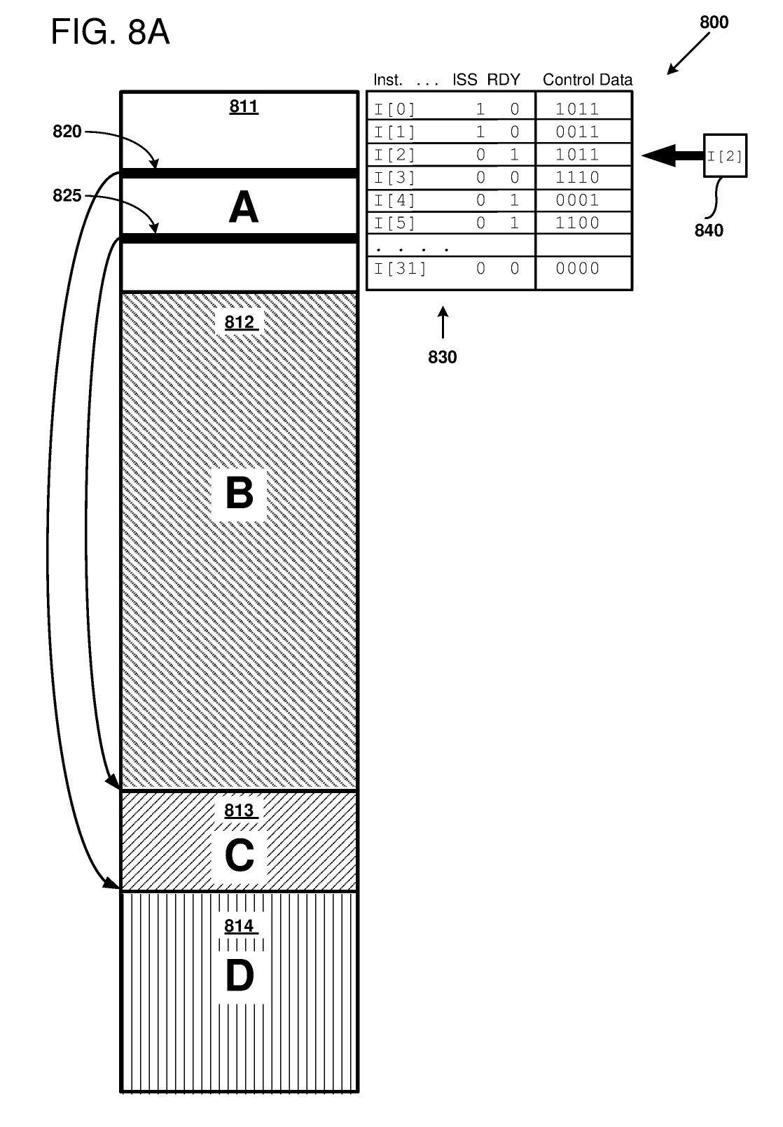

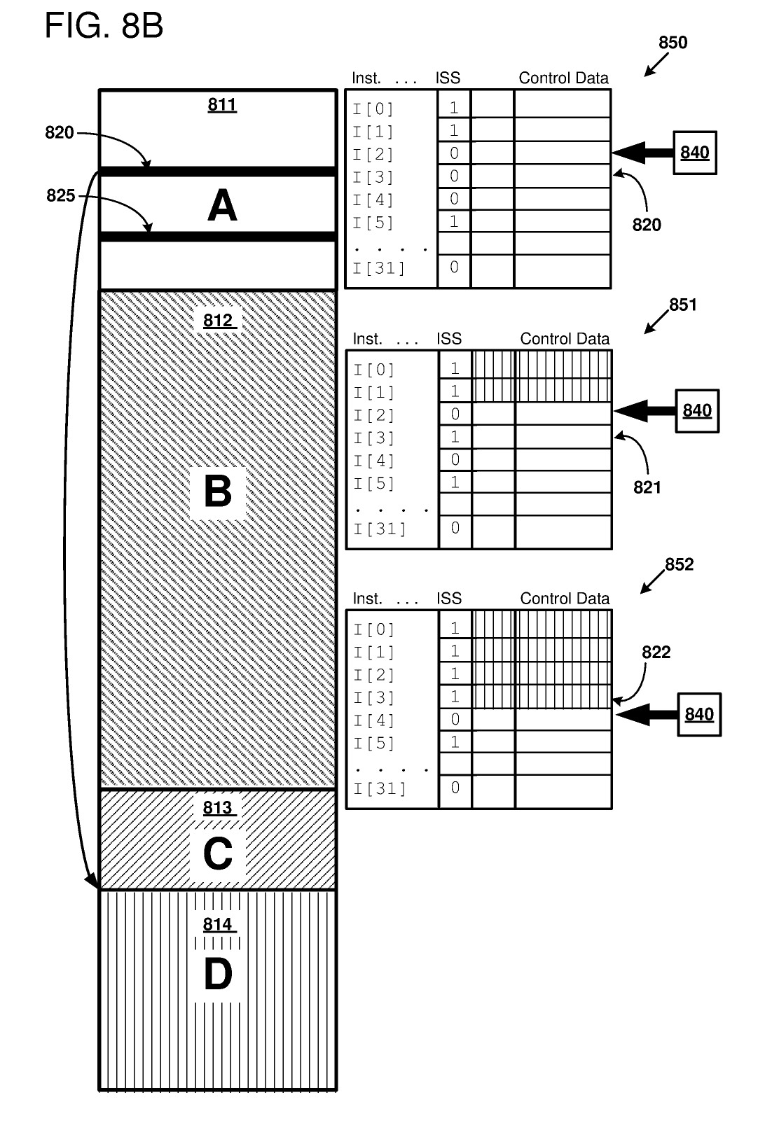

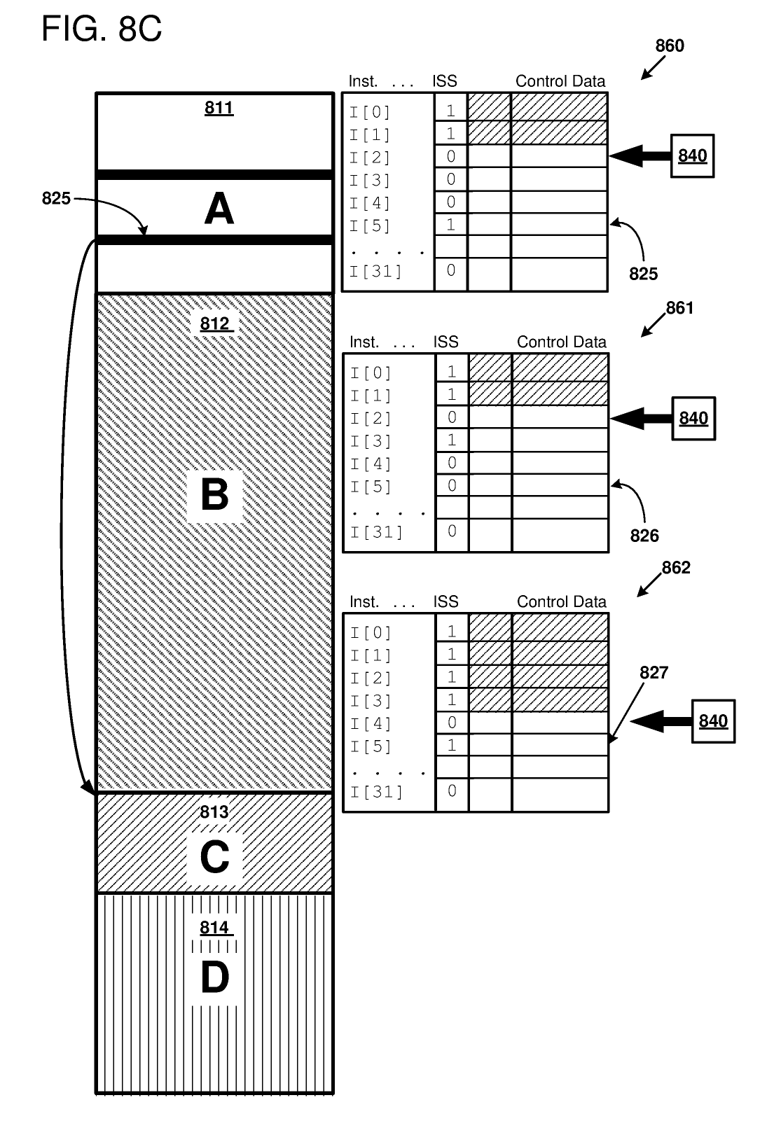

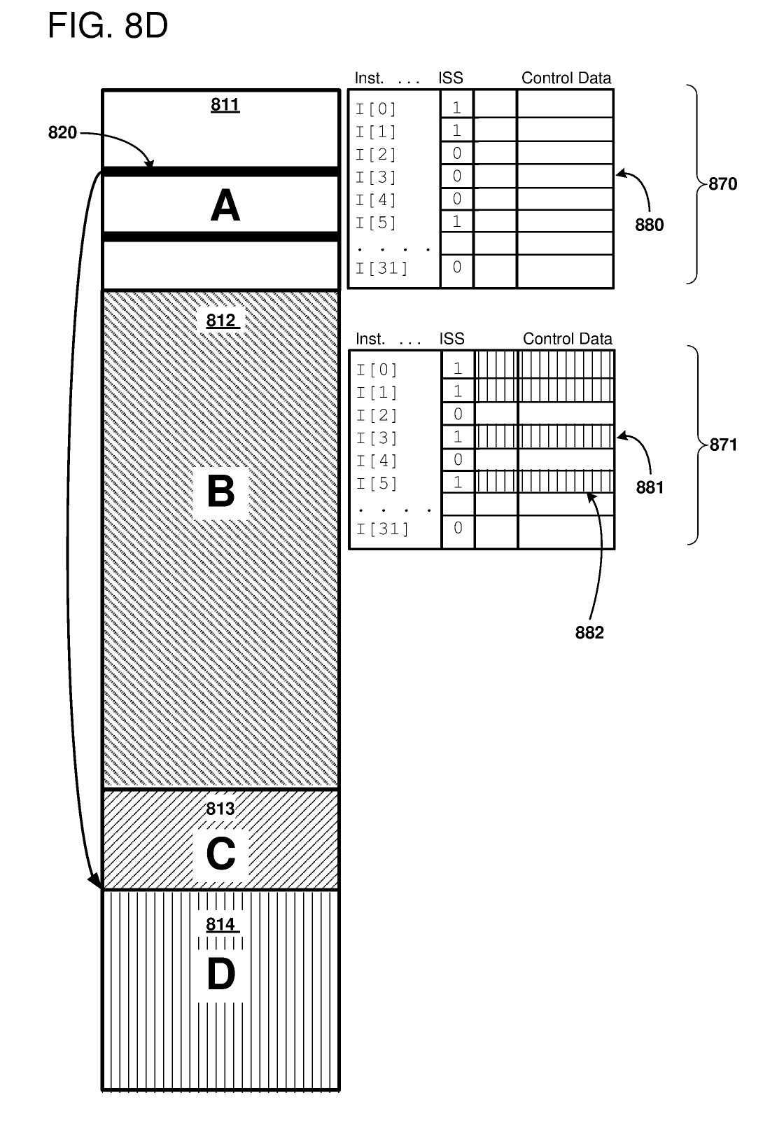

FIGS. 8A-8D are diagrams depicting a number of instruction blocks and associated instruction scheduler and decoder state as execution proceeds, according to certain examples and configurations of the disclosed technology. The instruction state shown can be stored in a memory coupled to an instruction scheduler, for example, using the hardware components discussed above regarding FIG. 7, including the instruction scheduler 720 and the decoded instruction store 740. The instruction blocks A-D illustrated in FIGS. 8A-8D are shown as they can be arranged in memory. Thus, if an instruction block includes a branch to another instruction block, then instructions of an intermediate instruction block located in-between will not by immediately executed next.

As shown in FIG. 8A, a first instruction block A 811 has two explicit exit points associated with branch instructions 820 and 825. The first instruction block 811 also has an implicit exit point to the next instruction block B 812. Thus, as execution of instruction block A 811 proceeds, if it is determined that neither of the branch instructions within the instruction block will execute, it is implied that the next instruction block will be instruction block 812, and thus an implicit branch is taken to block B. FIG. 8A further shows a simplified representation 830 of instruction state, including instruction scheduler and instruction control data state, for the current instruction block 811. As shown, the first two instructions I[0] and I[1] have issued, as issued bit (ISS) is set to 1. Three instructions, I[2], I[4], and I[5] are ready to issue, as indicated by the RDY bit being set to 1. A register 840 indicates the current instruction slot for which all previous instructions have already issued. In other words, all of the instructions prior to the pointed-to instruction, I[2], have issued. Thus, it is possible to reuse the storage for these first instruction slots prior to committing the first instruction block 811.

FIG. 8B is a simplified diagram representing instruction state in an example where there are two explicit branch instructions 820 and 825. At a first point in time, three instructions have issued (I[0], I[1], and I[5]), as indicated by the instruction state 850 shown. The register 840 has been updated to point to the instruction slot for which all previous instructions have issued. However, because none of the branch instructions have executed, it is not known where processor control will be transferred after instruction block 811 commits Thus, none of the issued instruction slots have been prefetched or predecoded.

At a second point in time, the instruction state 851 is updated. The first branch instruction 820, associated with INSTID I[3] has issued and executed, as indicated 821 in FIG. 8B. Since the branch instruction has executed, the address of the next instruction block is now known. The first two instruction slots now store instruction state data for the first two instructions of the next instruction block D 814, prior to the currently executing instruction block A 811 committing. As indicated by the vertical hashing in the instruction state 851, the control entry and ready state entries for instruction block D have been predispatched and thus their respective instruction state stored. The predispatched instruction state is indexed by the instruction identifier of the current instruction block. Other suitable techniques for indexing the instruction state can be used in alternative examples.

At a third point in time, the instruction state 852 is updated again, after executing instruction I[2]. The register 840 now points to instruction I[4], so additional instructions I[2] and I[3] for the next instruction block 814 can be predispatched, as indicated in FIG. 8B.

FIG. 8C illustrates an example of the block diagram 800 where a different instruction block, instruction block C 813, is speculatively executed. In other words, a branch predictor has determined that instruction block C 813 is the most likely branch location for the currently executing instruction block A 811. The branch instruction 825 is indicated in FIG. 8C. Thus, even though all of the predicates determining the target location for the branch instructions have not yet been definitively resolved, the processor has started to fetch, decode, and store instruction state for speculative block C 813 in the instruction scheduler and decoded instruction state memories. As shown in instruction state representation 860, the first two instruction slots I[0] and I[1] are storing instruction state for speculative block C 813. No other instruction slots are reused, because the register 840 is pointing to the first non-issued instruction, I[2]. At a second point in time, the instruction scheduler determines that an additional branch instruction I[3] will not ever issue, and so its issued bit is marked 1 so that progression of the block is not stalled. At a third point in time, all instructions up to I[4] have issued, as indicated by the register 840.

FIG. 8D illustrates the block diagram 800 for a number of instruction blocks where instruction scheduler and decoded instruction control data can be overwritten in a random access manner Instruction state 870 at a first point in time is represented, including state 880 for the branch instruction 820 that will eventually issue. Since at this first point in time the next instruction block address is not known, and the processor is configured to not perform speculative execution, prefetching and pre-decoding does not occur. At a second point in time, the instruction state 871 is updated after the branch instruction 820 (I[3]) has issued. In particular, since instruction I[5] has issued, not only are the first two instructions fetched, decoded, and have their instruction state stored in the memory, but other instructions slots 881 and 882 past the first non-issued instructions are fetched and stored in the memory. It should be noted that there is a design trade-off between maintaining a single issued instruction boundary, and monitoring the status of individual instructions to allow random access.

### XI. Example Method of Predispatching Instructions

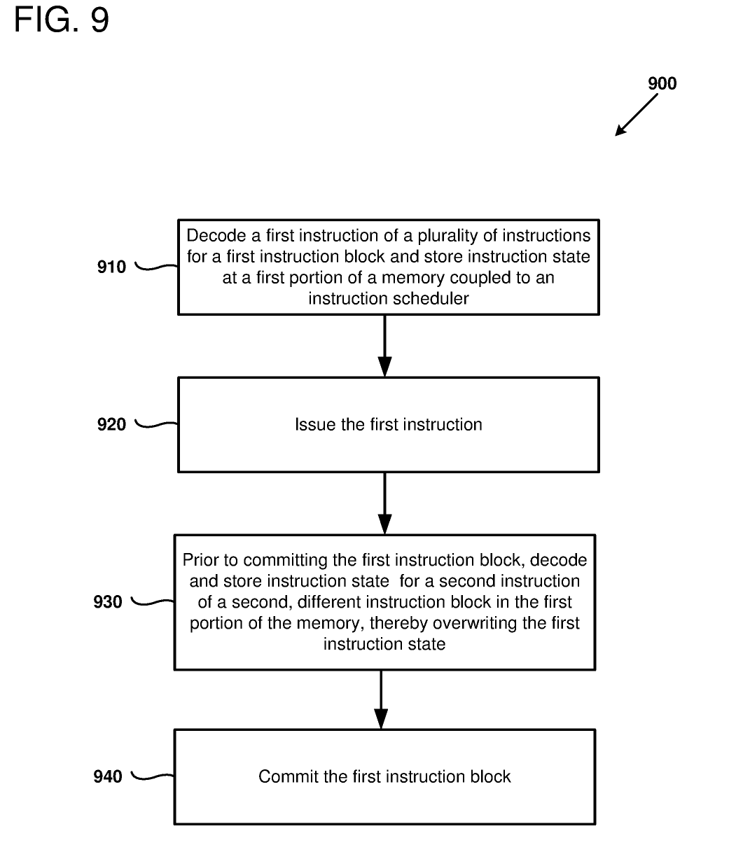

FIG. 9 is a flow chart 900 outlining an example method of operating a block-based processor with predispatch, as can be performed with certain examples of the disclosed technology. For example, the processor architectures discussed above regarding FIGS. 1-7 can be used to implement the illustrated methods.

At process block 910, a first instruction of a plurality of instructions for a current, first instruction block is dispatched, including storing instruction state at a first portion of a memory coupled to an instruction scheduler. In some examples, an instruction decoder is used to decode the first instruction to generate the instruction state. In some examples, decoded control state can also be received from the instruction decoder and stored in a decoded instruction store. In some examples, the instruction state generated by predispatching includes scheduler data including one or more of the following: decoded instruction ready state, active instruction ready state, ready state for input data or predicate operand of the first instruction, ready state for input data or predicate operand of the second instruction, instruction issued state, or an instruction inhibit state. It should be noted that the “current” instruction block refers to an in-flight instruction block that precedes a next instruction block. Frequently, disclosed methods of predispatching instructions will be performed for the oldest non-committed instruction block in an instruction block stream. However, it is possible in certain implemenations for other in-flight instruction blocks to be the “current” instruction blocks for purposes of predispatching of instructions in subsequent, next instruction blocks relative to a given current instruction block. In some examples, the current instruction block is the oldest in-flight instruction block being executed by a block-based processor core.

At process block 920, the first instruction is issued. Once the instruction has issued, execution of the instruction can begin. For example, control logic can used decoded instruction control data to generate signals for controlling the datapath to perform operations defined by the instruction.

At process block 930, prior to committing the first instruction block, a second instruction of a second instruction block (next instruction block), different than the first instruction block, is dispatched, including storing decoded instruction state decoded for the second instruction block in the first portion of the memory. This operation overwrites the first instruction state for the decoded first instruction from process block 910. In some examples, the decoding and storing instruction state occurs speculatively for a next instruction block selected by a branch predictor. In other examples, the decoding and storing does not occur until the next instruction block is definitively known for the current instruction block. In some examples, updating the instruction state includes setting an issued state bit in the instruction state stored at the first portion of the memory. In some examples, execution of the second instruction can be an initiated as well. In some examples, at least one additional instruction of the first instruction block is executed, and prior to committing the first instruction block, instruction state for the at least one additional instruction of the second instruction block is stored in a portion of the memory previously storing instruction state for the additional instructions.

In some examples of the illustrated method, a plurality of two or more instructions are dispatched and issued prior to dispatching instructions of the next, second instruction block. In some examples, a plurality of two or more instructions of the second instruction block are dispatched prior to the committing the first instruction block.

As discussed above regarding FIGS. 8A-8D, the operations performed at process block can be performed incrementally in certain implementations. For example, as additional instructions in the first instruction block issue, the instruction state data for the next instruction block is stored in the issued instruction slots. In some examples, a register stores a pointer to indicate the lowest INSTID of a non-issued instruction. In other examples, instruction slots can be written to in a random access manner. The next instruction block can be determined non-speculatively (after the next instruction block is definitively known) or speculatively. In cases where a mis-prediction occurs, the instruction slots will be re-written with data for the newly-determined next instruction block.

At process block 940, the first instruction block is committed. As discussed in further detail above, committing the instruction block includes writing out system registers and condition codes, storing data for memory load and store operations, and writing values to the register file. The committing can occur while instructions for the second instruction block, which were decoded and stored while the first instruction block was the current instruction block, are executed.

### XII. Example Method of Generating Object Code for a Block-Based Processor

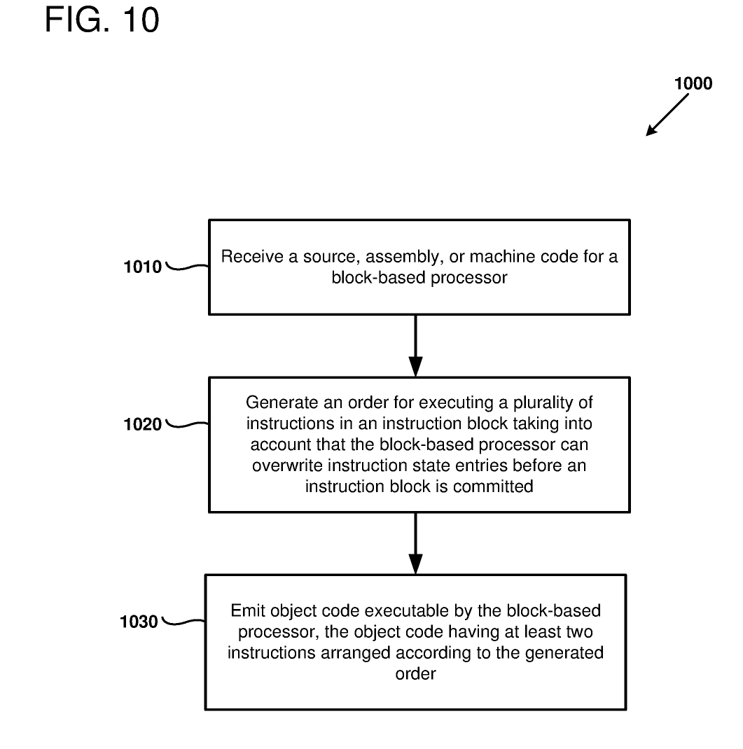

FIG. 10 is a block diagram 1000 outlining an example method of generating object code for a block-based processor, as can be performed in certain examples of the disclosed technology. For example, a general purpose processor or a block-based processor can be used to generate object code for execution by a block-based processor.

At process block 1010, source, assembly, and/or machine code for a block based processor are received. The source code can be expressed in any suitable programming language, or expressed in assembly or machine code.

At process block 1020, an ordering is generated for executing a number of instructions in the instruction block. The generated order takes into account that the block-based processor can overwrite instruction state entries before an instruction block is committed by the processor. For example, it may be advantageous in certain processor architectures to order the instructions such that higher latency instructions, or instructions with more or fewer dependencies are ordered to execute first. As a further example, instructions that generate results that will help determine which exit location a block will branch to can be ordered earlier in the block. Thus, when the next instruction block is determined, more instruction slots can be predispatched at an earlier point in time. In some examples, the ordering is generated based at least in part on assumptions made about when instructions in a current instruction block will execute. In some examples, the ordering is based at least in part on assumptions programmed into a compiler regarding when it may be advantageous to begin fetching, decoding, and issuing instructions for the next instruction block.

At process block 1030, object code is omitted that is executable by a block-based processor. The object code includes at least two block based processor instructions that are arranged according to the order generated at process block 1020. The emitted object code can be transmitted to another computer via a communications network and/or stored in any suitable computer readable storage media.

### XIII. Example Computing Environment

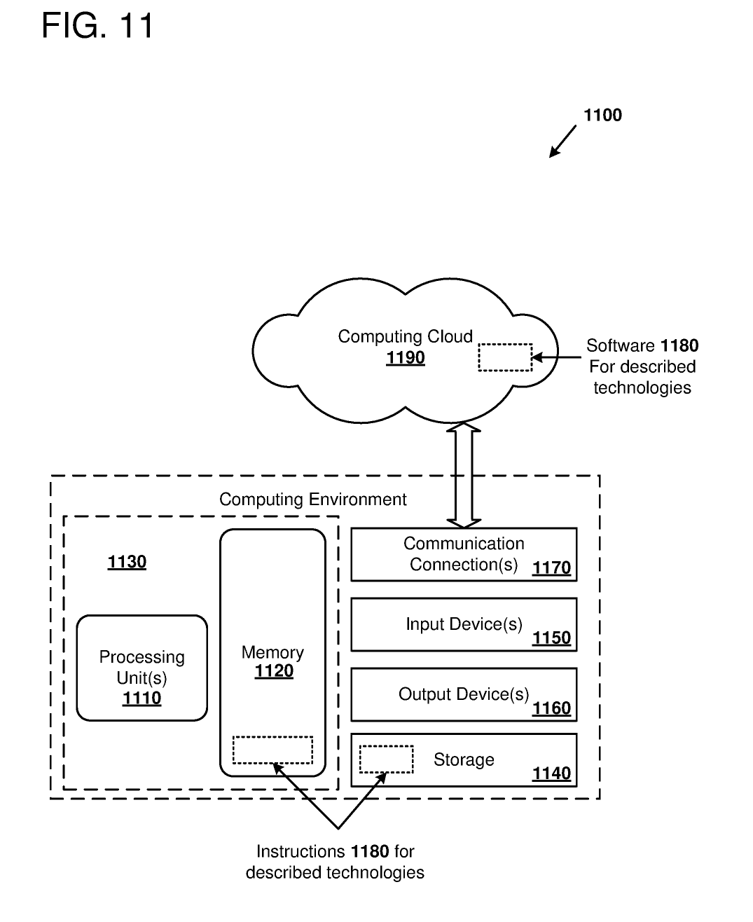

FIG. 11 illustrates a generalized example of a suitable computing environment 1100 in which described embodiments, techniques, and technologies, including generating and using instruction state for fetching, decoding, and dispatching instructions while executing an instruction block with a block-based processor, can be implemented.

The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 11, the computing environment 1100 includes at least one block-based processing unit 1110 and memory 1120. In FIG. 11, this most basic configuration 1130 is included within a dashed line. The block-based processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software 1180, images, and video that can, for example, implement the technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and that can be accessed within the computing environment 1100. The storage 1140 stores instructions for the software 1180, plugin data, and messages, which can be used to implement technologies described herein.

The input device(s) 1150 may be a touch input device, such as a keyboard, keypad, mouse, touch screen display, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, video, or other data in a modulated data signal. The communication connection(s) 1170 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1190. For example, disclosed compilers and/or block-based-processor servers are located in the computing environment 1130, or the disclosed compilers can be executed on servers located in the computing cloud 1190. In some examples, the disclosed compilers execute on traditional central processing units (e.g., RISC or CISC processors).

Computer-readable media are any available media that can be accessed within a computing environment 1100. By way of example, and not limitation, with the computing environment 1100, computer-readable media include memory 1120 and/or storage 1140. As should be readily understood, the term computer-readable storage media includes the media for data storage such as memory 1120 and storage 1140, and not transmission media such as modulated data signals.

One or more computer-readable storage media may store computer-readable instructions that when executed cause a computer to perform the method for compiling instructions targeted for execution by a block-based processor. A block-based processor may be configured to execute computer-readable instructions generated by the method.

### XIV. Additional Examples of the Disclosed Technology

Additional examples of the disclosed subject matter are discussed herein in accordance with the examples discussed above.

In some examples of the disclosed technology, a method of operating a block-based processor includes, dispatching a first instruction of a plurality of instructions for a first (current) instruction block, the dispatching including storing instruction state at a first portion of a memory coupled to an instruction scheduler. The example method further includes issuing the first instruction, and, prior to committing the first instruction block, dispatching a second instruction of a second, different instruction block (next instruction block) in the first portion of the memory, thereby overwriting the first instruction state by storing instruction state for the second instruction of the second instruction block, and committing the first instruction block. The instructions can be dispatching using an instruction decoder that decodes encoded instructions stored in an instruction cache to generate instruction scheduler data and decoded instruction state data. In some examples, the first instruction block is always the oldest instruction block in the currently in-flight set of instructions. In some examples, the first (current) instruction block can be a newer instruction block.

In some examples of the method, issuing the first instruction includes updating the instruction state to indicate that the first instruction has issued. For example, active ready state, such as an issued or inhibit bit can be set in an instruction scheduler memory. In some examples, updating the instruction state includes setting an issued state bit in the instruction state stored at the first portion of the memory. The instruction state can be stored in any suitable memory, including latches, flip-flops, registers, or random access memories, whether the processor is implemented using a custom integrated circuit or an FPGA. In some examples, the memory forms a portion of an instruction scheduler and/or a decoded instruction store.

In some examples, the instruction state comprises decoded instruction control data used to generate control signals for an instruction pipeline or datapath of the block-based processor, and the decoding includes generating the decoded control data from an encoding of the first instruction.

In some examples, the instruction state includes scheduler data including at least one or more of the following: decoded instruction ready state, active instruction ready state, ready state for an input data or predicate operand of the first instruction, ready state for an input data or predicate operand of the second instruction, instruction issued state, or instruction inhibit state.

In some examples, the method includes, after the committing the first instruction block, clearing an issued state bit or inhibit state bit in the instruction state stored at the first portion of the memory, thereby allowing the second instruction to issue when the second instruction's dependencies are satisfied.

In some examples, the storing the instruction state for the second instruction is performed speculatively. In some examples, prior to the committing the first instruction block, execution of the second instruction is initiated.

In some examples of the method, the dispatching for the first instruction block may be preceded by fetching and/or decoding one or more instructions of the first instruction block. In some examples, dispatching for the second instruction block may be preceded by fetching and/or decoding one or more instructions of the second instruction block.

In some examples, the method further includes executing at least one additional instruction of the first instruction block, and, prior to the committing the first instruction block, storing instruction state for the at least one additional instruction of the second instruction block in a portion of the memory previously storing instruction state for the additional executed instructions of the first instruction block. In some examples, any number of instructions of the second, next instruction block can be predispatched as instructions of the first instruction block are issued, prior to committing the first instruction block.

In some examples of the disclosed technology, an apparatus includes an instruction decoder configured to decode instructions in a current instruction block and dispatch instruction state to an instruction scheduler. The instruction scheduler is configured to issue individual instructions within the current instruction block and is coupled to memory storing instruction state entries for the current instruction block. The apparatus is configured to, prior to committing the current instruction block, overwrite instruction state entries for individual instructions of the current instruction block in the memory as the corresponding individuals instructions are issued by the instruction scheduler. In some examples, the apparatus comprises one or more block-based processor cores.

In some examples, the apparatus instruction state entries include decoded instruction control entries and instruction ready state entries. In some examples, the instruction decoder is coupled to the memory, which includes a decoded instruction store storing a decoded instruction control entry at an index for its respective instruction of the current instruction block. The instruction scheduler is coupled to the memory, which further includes an instruction ready store storing a ready state entry at an index for its respective instruction of the current instruction block.

In some examples, the instruction state, such as the decoded instruction control entry and the ready state entry are indexed by an instruction identifier of the current instruction block.

In some examples, the apparatus further includes a datapath configured to execute the current instruction block instructions, the datapath being configured to receive control signals generated using instruction state entries generated by the instruction decoder.

In some examples, the apparatus is further configured to overwrite instruction state entries in a random-access manner In other examples, the instruction scheduler includes a register indicating an index of a non-issued individual instruction, and the apparatus is further configured to overwrite instruction state entries up to the index of the non-issued individual instruction.

In some examples, the apparatus is further configured to: overwrite the instruction state entries with instructions of a next instruction block different from the current instruction block. The entries are overwritten prior to committing the current or oldest in-flight instruction block. The instruction state entries may be overwritten by fetching, decoding, and dispatching the instruction state entries to the memory.

In some examples the apparatus is further configured to speculatively overwrite at least one of the instruction state entries prior to determining that the next instruction block will become a current instruction block, or determining that the next instruction block will become the oldest instruction block.

One or more computer-readable storage media store computer-readable instructions that when executed by a block-based processor, causes the processor to perform any one of the disclosed methods. In some examples, the apparatus can be coupled to the computer-readable storage media and executed the instructions.

In some examples of the disclosed technology, one or more computer-readable storage media store computer-readable instructions that when executed by a processor, causes the processor to perform a method implemented with a native compiler, a cross compiler, or a just-in-time compiler. The method includes receiving source, assembly, and/or machine code for a block-based processor, generating an order for arranging a plurality of instructions in an instruction block. The generated order can be selected taking into account that the block-based processor can overwrite instruction state entries before an instruction block is committed. In some examples, the generated order is selected such that an improved processor performance characteristics are sought. For example, the order can be selected for the current or its next instruction block to increase a rate at which instructions are issued in the block-based processor. In some examples, the compiler emits object code executable by the block-based processor, the object code having at least two instructions arranged according to the generated order. In some examples, a computer-readable storage media stores the object code emitted by executing the disclosed compiler methods.

One or more computer-readable storage media (such as storage devices and/or memory) can store computer-readable instructions that when executed by a computer cause the computer to perform any of the methods of generating and using instruction state for fetching and decoding instructions while executing an instruction block with a block-based processor disclosed herein. A block-based processor can be configured to execute computer-readable instructions generated by the method.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims and their equivalents.

I claim:

1. A method of operating a block-based processor, the method comprising:
with an instruction decoder, dispatching a first instruction of a plurality of instructions for a first instruction block, the dispatching comprising storing instruction state at a first portion of a memory coupled to an instruction scheduler;
issuing the first instruction;
prior to committing the first instruction block, dispatching a second instruction of a second, different instruction block in the first portion of the memory, thereby overwriting the first instruction state by storing instruction state for the second instruction of the second instruction block; and
committing the first instruction block.

2. The method of claim 1, wherein the issuing the first instruction comprises updating the instruction state to indicate that the first instruction has issued.

3. The method of claim 2, wherein the updating the instruction state comprises setting an issued state bit in the instruction state stored at the first portion of the memory.

4. The method of claim 1, wherein the memory forms a portion of an instruction scheduler and/or a decoded instruction store.

5. The method of claim 1, wherein the instruction state comprises decoded instruction control data used to generate control signals for a datapath of the block-based processor, and wherein the decoding comprises generating the decoded control data from an encoding of the first instruction.

6. The method of claim 1, wherein the instruction state comprises scheduler data including at least one or more of the following: decoded instruction ready state, active instruction ready state, ready state for an input data or predicate operand of the first instruction, ready state for an input data or predicate operand of the second instruction, instruction issued state, or instruction inhibit state.

7. The method of claim 1, further comprising, after the committing the first instruction block, clearing an issued state bit or inhibit state bit in the instruction state stored at the first portion of the memory, thereby allowing the second instruction to issue when the second instruction's dependencies are satisfied.

8. The method of claim 1, wherein the storing the instruction state for the second instruction is performed speculatively.

9. The method of claim 1, further comprising:
prior to the committing the first instruction block, initiating execution of the second instruction.

10. The method of claim 1, further comprising:
executing at least one additional instruction of the first instruction block; and
prior to the committing the first instruction block, storing instruction state for the at least one additional instruction of the second instruction block in a portion of the memory previously storing instruction state for the additional executed instructions of the first instruction block.

11. An apparatus comprising:
an instruction decoder configured to decode instructions in a current instruction block;
an instruction scheduler configured to issue individual instructions within the current instruction block;
memory storing instruction state entries for the current instruction block; and
wherein the apparatus is configured to, prior to committing the current instruction block, overwrite instruction state entries for individual instructions of the current instruction block in the memory as the corresponding individuals instructions are issued by the instruction scheduler.

12. The apparatus of claim 11, wherein:
the instruction state entries comprise decoded instruction control entries and instruction ready state entries; and
the instruction decoder is coupled to the memory, which memory comprises a decoded instruction store storing a decoded instruction control entry at an index for its respective instruction of the current instruction block; and
the instruction scheduler is coupled to the memory, which further comprises an instruction ready store storing a ready state entry at an index for its respective instruction of the current instruction block.

13. The apparatus of claim 12, wherein the decoded instruction control entry and the ready state entry are indexed by an instruction identifier of the current instruction block.

14. The apparatus of claim 11, further comprising a datapath configured to execute the current instruction block instructions, the datapath being configured to receive control signals generated using instruction state entries generated by the instruction decoder.

15. The apparatus of claim 11, wherein the apparatus is further configured to overwrite instruction state entries in a random-access manner

16. The apparatus of claim 11, wherein the instruction scheduler comprises a register indicating an index of a non-issued individual instruction, and wherein the apparatus is further configured to overwrite instruction state entries up to the index of the non-issued individual instruction.

17. The apparatus of claim 11, wherein the apparatus is further configured to:
overwrite the instruction state entries with instructions of a next instruction block different from the current instruction block.

18. The apparatus of claim 17, wherein the apparatus is further configured to speculatively overwrite at least one of the instruction state entries prior to determining that the next instruction block will become a current instruction block.

19. One or more computer-readable storage media storing computer-readable instructions that when executed by a processor, causes the processor to perform a method implemented with a native compiler, a cross compiler, or a just-in-time compiler, the method comprising:
receiving source, assembly, or machine code for a block-based processor;
generating an order for arranging a plurality of instructions in an instruction block selected to increase a rate at which instructions are issued in the block-based processor, the generated order taking into account that the block-based processor can overwrite instruction state entries before an instruction block is committed; and
emitting object code executable by the block-based processor, the object code having at least two instructions arranged according to the generated order.

20. A computer-readable storage media storing the object code emitted by executing the computer-readable instructions stored in the computer-readable storage media of claim 19.
